(19) United States
(12) Patent Application Publication
(10) Pub. No.: US 2009/0040006 A1
(43) Pub. Date: Feb. 12, 2009

(54) ELECTRICAL FUSE WITH ENHANCED PROGRAMMING CURRENT DIVERGENCE

(75) Inventors: Dureseti Chidambarrao, Weston, CT (US); William K. Henson, Beacon, NY (US); Deok-kee Kim, Bedford Hills, NY (US); Chandrasekharan Kothandaraman, Hopewell Junction, NY (US)

Correspondence Address: SCULLY, SCOTT, MURPHY & PRESSER, P.C., 400 GARDEN CITY PLAZA, Suite 300, GARDEN CITY, NY, 11530, US

(73) Assignee: INTERNATIONAL BUSINESS MACHINES CORPORATION, Armonk, NY (US)

(21) Appl. No.: 11/835,846

(22) Filed: Aug. 8, 2007

(51) Int. Cl. H01H 85/143; B23P 19/00

(52) U.S. Cl. 337/227; 29/825

(57) ABSTRACT

A layer of semiconductor material is patterned to form a cathode semiconductor portion, a fuselink semiconductor portion, and an anode semiconductor portion. A first metal layer is deposited on the patterned semiconductor material layer. A dielectric material layer is deposited and lithographically patterned to cover a middle portion of the fuselink, followed by a deposition of a second metal layer. A thin metal semiconductor alloy is formed in the middle of the fuselink and thick metal semiconductor alloy alloys are formed abutting the thin metal semiconductor alloy alloy. The resulting inventive electrical fuse has interfaces at which a thinner metal semiconductor alloy abuts a thicker metal semiconductor alloy in the fuselink. The divergence of electrical current is enhanced at the interfaces due to a sudden change of a cross-sectional area available for current conduction.

### FIELD OF THE INVENTION

The present invention relates to semiconductor devices, and particularly to a programmable semiconductor fuse with enhanced programming current divergence.

### BACKGROUND OF THE INVENTION

Electrically programmable semiconductor fuses, or electrical fuses in short as it is referred to in this invention, have been used in semiconductor circuits to provide alterations in the functionality of the circuitry. Typical examples of applications of electrical fuses include: providing redundancy to enable repairs of imperfect chips, storage of secure and permanent information, selection of a particular configuration for chip operation, tuning analogue circuit components, optimizing overall circuit performance, and/or replacing defective circuit elements with redundant circuit elements.

Electrical fuses are programmed by the physical alteration of the structure of the electrical fuses. The most commonly used structure of electrical fuses employs a vertical stack comprising a semiconducting material and a conducting material. While the most common material for the vertical stack is polysilicon and silicide, other semiconducting materials and other conducting materials may be utilized if similar electromigration properties can be found in the combined stack of the two materials. In general, the stack comprises a layer of semiconductor material and a layer of a metal semiconductor alloy, which may be a silicide. This stack is patterned such that a narrow and long piece of material, called “fuselink” or “fuse neck,” is adjoined by two large plates, called “cathode” and “anode” respectively, depending on the polarity of electrical bias applied to the electrical fuse during programming. Electrical current of relatively high density flows through the fuselink when a sufficiently high voltage bias is applied across the cathode and the anode. The programming current may be high enough to cause the electrical fuses to rupture by a sudden increase in temperature in the physical structure of the electrical fuses. This type of programming is commonly referred to as “rupture mode programming.” Alternatively, the level of the programming current may be moderated to cause a controlled electromigration of the material inside the electrical fuse structure. This alternative mode of programming is commonly referred to as “electromigration mode programming.” Both programming methods raise the resistance of the programmed fuse compared to that of intact fuses.

By measuring the resistance of electrical fuses, it can be determined whether the electrical fuse has been programmed or intact. While it may not be necessary to measure the exact value of the fuse resistance to determine the state of the fuse, it is generally necessary to determine whether the fuse resistance has been raised by a significant amount above the detection limit of the sensing circuitry. Typically, this is done by setting the resistance for a reference resistor at a value about 3˜10 times that of an intact electrical fuse and comparing the resistance of the fuse with that of the reference resistor. A difference between the resistance of the reference resistor and the resistance of an intact fuse is often necessary to insure margin in the functionality of the sensing circuitry under adverse operating conditions of the chip.

Reliable programming of electrical fuses in an electromigration mode requires a minimum level of divergence of electrical current density at the cathode to induce electromigration of a metal semiconductor alloy at the cathode. While the divergence of electrical current is proportional to the magnitude of the electrical current through the fuselink, the size of a programming transistor, and correspondingly, the area occupied by the programming transistor, are proportional to the magnitude of the electrical current to be supplied to the fuselink during programming. However, the divergence of electrical current is also a function of geometry of the electrical fuse structure. In principle, the paths of the electrical current for programming an electrical fuse may be engineered to induce a higher level of divergence of electrical current density by manipulating the geometry of the electrical fuse structure.

Therefore, an electrical fuse structure that produces a high level of divergence of electrical current at the cathode, and methods of manufacturing the same are desired.

### SUMMARY OF THE INVENTION

The present invention provides an electrical fuse structure having a geometry that facilitates programming by forming a thin metal semiconductor alloy in a middle portion of a fuselink, while forming thick metal semiconductor alloys abutting the thin metal semiconductor alloy on the rest of the fuselink, and methods of manufacturing the same.

Specifically, the present invention provides an electrical fuse structure in which a middle portion of a fuselink has a thin metal semiconductor alloy that abuts thick metal semiconductor alloys on end portions of the fuselink, thus enhancing the divergence of the current at a cathode. The thick metal semiconductor alloy may, or may not, comprise substantially the same material as the thin metal semiconductor alloy. To form the inventive electrical fuse, a layer of semiconductor material is patterned to form a cathode semiconductor portion, a fuselink semiconductor portion, and an anode semiconductor portion. A first metal layer is deposited on the patterned semiconductor material layer. A dielectric material layer is deposited and lithographically patterned to cover a middle portion of the fuselink. A second metal layer is deposited on the first metal layer and the patterned dielectric material layer. Since the first and second metal layers are available for reaction in the area outside the patterned dielectric material layer, a thick metal semiconductor alloy is formed in that area. Since only the first metal layer is available for reaction in the area of the patterned dielectric material layer, a thin metal semiconductor alloy is formed in that area. The resulting inventive electrical fuse has interfaces at which a thinner metal semiconductor alloy abuts a thicker metal semiconductor alloy in the fuselink. The divergence of electrical current is enhanced at the interfaces due to a sudden change of a cross-sectional area available for current conduction.

According to an aspect of the present invention, an electrical fuse is disclosed, which comprises:

a cathode located on a semiconductor substrate and including a cathode semiconductor portion and a cathode metal semiconductor alloy portion, the cathode metal semiconductor alloy portion having a first thickness and vertically abutting the cathode semiconductor portion;

an anode located on the semiconductor substrate and disjoined from the cathode and including an anode semiconductor portion and an anode metal semiconductor alloy portion, the anode metal semiconductor alloy having the first thickness and vertically abutting the anode semiconductor portion; and

a fuselink located on the semiconductor substrate and including.
a first fuselink portion containing a first semiconductor portion and a first metal semiconductor alloy portion, wherein the first metal semiconductor alloy portion has the first thickness and laterally abuts the cathode metal semiconductor alloy portion and vertically abuts the first semiconductor portion;
a second fuselink portion containing a second semiconductor portion and a second metal semiconductor alloy portion, wherein the second metal semiconductor alloy portion has a second thickness and laterally abuts the first metal semiconductor alloy portion and vertically abuts the second semiconductor portion, and the second thickness is less than the first thickness; and
a third fuselink portion containing a third semiconductor portion and a third metal semiconductor alloy portion, wherein the third metal semiconductor alloy portion has the first thickness and laterally abuts second metal semiconductor alloy portion and the anode metal semiconductor alloy portion and vertically abuts the third semiconductor portion.

In some embodiments, the cathode metal semiconductor alloy portion, the first metal semiconductor alloy portion, the third metal semiconductor alloy portion, and the anode metal semiconductor alloy portion have a first composition and the second metal semiconductor alloy portion has a second composition. The first composition and the second composition may be substantially the same, or alternatively, the first composition and the second composition may be different.

In some instances, the first composition may comprise a first metal silicide and the second composition may comprise a second metal silicide.

In some other embodiments, a full set of metallic components, i.e., the complete set of metallic components, of the first composition may contain at least one additional metallic element than a full set of metallic components of the second composition.

The inventive electrical fuse may further comprise shallow trench isolation located in the semiconductor substrate and abutting the cathode semiconductor portion, the first semiconductor portion, the second semiconductor portion, the third semiconductor portion, and the anode semiconductor portion.

In a further embodiment, the cathode semiconductor portion, the first semiconductor portion, the second semiconductor portion, the third semiconductor portion, and the anode semiconductor portion may have substantially the same height.

In a yet further embodiment, the cathode semiconductor portion, the anode semiconductor portion, the first, second, and third semiconductor portions may be doped substantially at the same doping concentration and with the same dopant type.

According to another aspect of the present invention, a method of manufacturing an electrical fuse is discloses, which comprises:

forming a layer of semiconductor material on a semiconductor substrate;

patterning the layer of semiconductor material into a cathode semiconductor portion, a fuselink semiconductor portion, and an anode semiconductor portion, wherein the fuselink semiconductor portion laterally abuts the cathode semiconductor portion and the anode semiconductor portion;

forming a first metal layer directly on at least the entirety of a top surface of the fuselink semiconductor portion;

depositing and patterning a dielectric material layer on the first metal layer so that a middle portion of the fuselink semiconductor portion is covered by the dielectric material layer, while two end portions of the fuselink semiconductor portion are not covered by the dielectric material layer;

forming a second metal layer directly on the first metal layer and the dielectric material layer; and

forming a first metal semiconductor alloy having a first thickness at least on the two end portions of the fuselink, while forming a second metal semiconductor alloy having a second thickness on the middle portion of the fuselink, wherein the second thickness is less than the first thickness.

In an embodiment, the first metal layer and the second metal layer may have substantially the same composition, or different compositions.

In another embodiment, the first metal semiconductor alloy may comprise a first metal silicide and the second metal semiconductor alloy may comprise a second metal silicide.

### BRIEF DESCRIPTION OF THE DRAWINGS

FIGS. 1A-3B show structures of an exemplary electrical fuse according to the present invention at various stages of a manufacturing sequence. Figures with the suffix “A” are vertical cross-sectional views, and are taken along the plane A-A′ if shown in another figure with the same numerical label. Figures with the suffix “B” are top-down views of the corresponding figure with the same numeric label and the suffix “A.” FIG. 1C is a horizontal cross-sectional view of the structure in FIG. 1A along the plane C-C′.

### DETAILED DESCRIPTION OF THE INVENTION

As stated above, the present invention relates to a programmable semiconductor fuse with enhanced programming current divergence and methods of manufacturing the same, which are now described in detail with accompanying figures. It is noted that like and corresponding elements are referred to by like reference numerals.

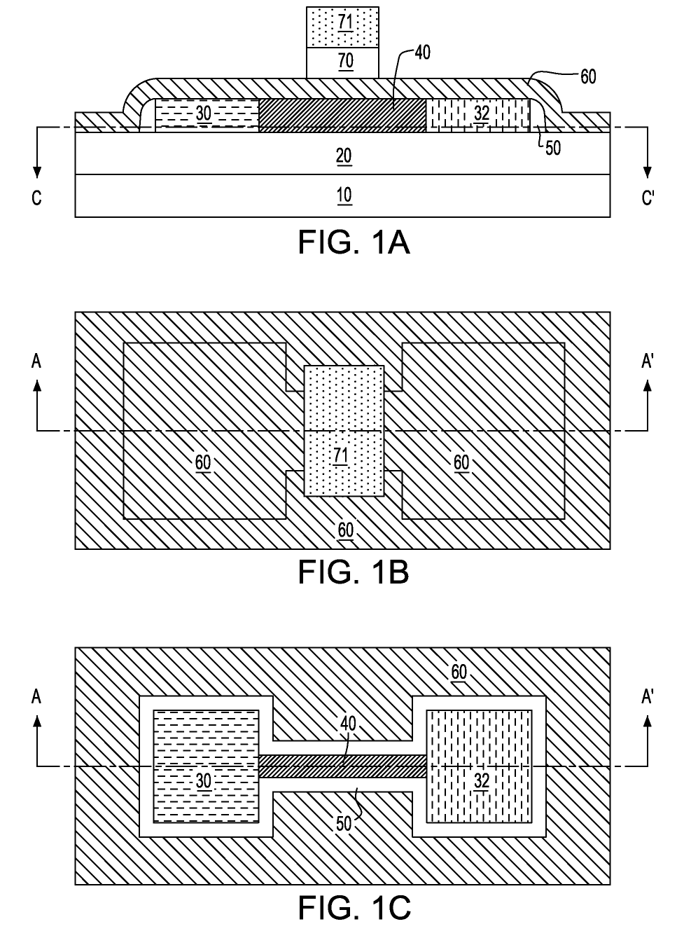

Referring to FIGS. 1A-1C, an exemplary semiconductor structure according to the present invention comprises a semiconductor substrate containing shallow trench isolation 20 located in a substrate semiconductor layer 10, a cathode semiconductor portion 30, a fuselink semiconductor portion 40, and an anode semiconductor portion 32. The fuselink semiconductor portion 40 laterally abuts the cathode semiconductor portion 30 and the anode semiconductor portion 32. Preferably, the cathode semiconductor portion 30, the fuselink semiconductor portion 40, and the anode semiconductor portion 32 are formed by depositing and lithographically patterning a layer of semiconductor material.

The semiconductor material may be amorphous or polycrystalline. Further, the semiconductor material may comprise silicon, germanium, carbon, III-V semiconductor alloy, II-VI semiconductor alloy, and/or a combination thereof. Each of the cathode semiconductor portion 30, the fuselink semiconductor portion 40, and the anode semiconductor portion 32 may, or may not, be doped with dopants to optimize performance of an electrical fuse to be formed. The cathode semiconductor portion 30, the fuselink semiconductor portion 40, and the anode semiconductor portion 32 may have the same doping. Preferably, a dielectric spacer 50 is formed on the periphery of the collective structure of the cathode semiconductor portion 30, the fuselink semiconductor portion 40, and the anode semiconductor portion 32.

A first metal layer 60 is deposited directly on at least the entirety of the top surface of the fuselink semiconductor portion 40. Preferably, the first metal layer 60 is deposited on the entire top surface of the exemplary semiconductor structure. Optionally, portions of the first metal layer 60 may removed by a combination of lithographic methods and reactive ion etching outside the area of the fuselink semiconductor portion 40.

The first metal layer 60 comprises a metal capable of forming a metal semiconductor alloy when reacted with the semiconductor material of the cathode semiconductor portion 30, the fuselink semiconductor portion 40, and the anode semiconductor portion 32. For example, the cathode semiconductor portion 30, the fuselink semiconductor portion 40, and the anode semiconductor portion 32 may comprise silicon and the first metal layer 60 may comprise a metal or a metal alloy that may form a silicide. For example, the metal or the metal alloy may comprise elements such as Ta, Ti, Co, W, Ni, Pt, Os, Ir, Mo, and/or other transition metals and refractory metals.

The thickness of the first metal layer 60 may be from about 2 nm to about 20 nm, and typically from about 4 nm to about 7 nm. The first metal layer 60 may be deposited, for example, by physical vapor deposition (PVD).

A dielectric material layer 70 is deposited on the first metal layer 60 and lithographically patterned using a photoresist 71 and etched so that a middle portion of the fuselink semiconductor portion 40 is covered by the dielectric material layer 70, while two end portions of the fuselink semiconductor portion 40 are not covered by the dielectric material layer 70. The dielectric material layer 70 may comprise a nitride or an oxide, such as silicon nitride. The thickness of the dielectric material layer 70 may be from about 5 nm to about 70 nm, and typically from about 20 nm to about 50 nm.

Referring to FIG. 2A, a second metal layer 80 is formed directly on the first metal layer 60 and the dielectric material layer 70. The second metal layer 80 comprises a metal capable of forming a metal semiconductor alloy when reacted with the semiconductor material of the cathode semiconductor portion 30, the fuselink semiconductor portion 40, and the anode semiconductor portion 32. For example, the cathode semiconductor portion 30, the fuselink semiconductor portion 40, and the anode semiconductor portion 32 may comprise silicon and the second metal layer 80 may comprise a metal or a metal alloy that may form a silicide. The second metal layer 80 may comprise the same composition, or alternatively, may comprise a different have different compositions. The thickness of the second metal layer 80 may be from about 2 nm to about 20 nm, and typically from about 4 nm to about 7 nm. The second metal layer 80 may be deposited, for example, by physical vapor deposition (PVD).

The fuselink semiconductor portion 40 is subdivided into three segments for the purpose of description of the present invention. The segment of the fuselink semiconductor portion 40 directly underneath the dielectric material layer 70 constitutes a second semiconductor portion 40B. The segment of the fuselink semiconductor portion 40 between the cathode semiconductor portion 30 and the second semiconductor portion 40B constitutes a first semiconductor portion 40A. The segment of the fuselink semiconductor portion 40 between the anode semiconductor portion 32 and the second semiconductor portion 40B constitutes a third semiconductor portion 40C.

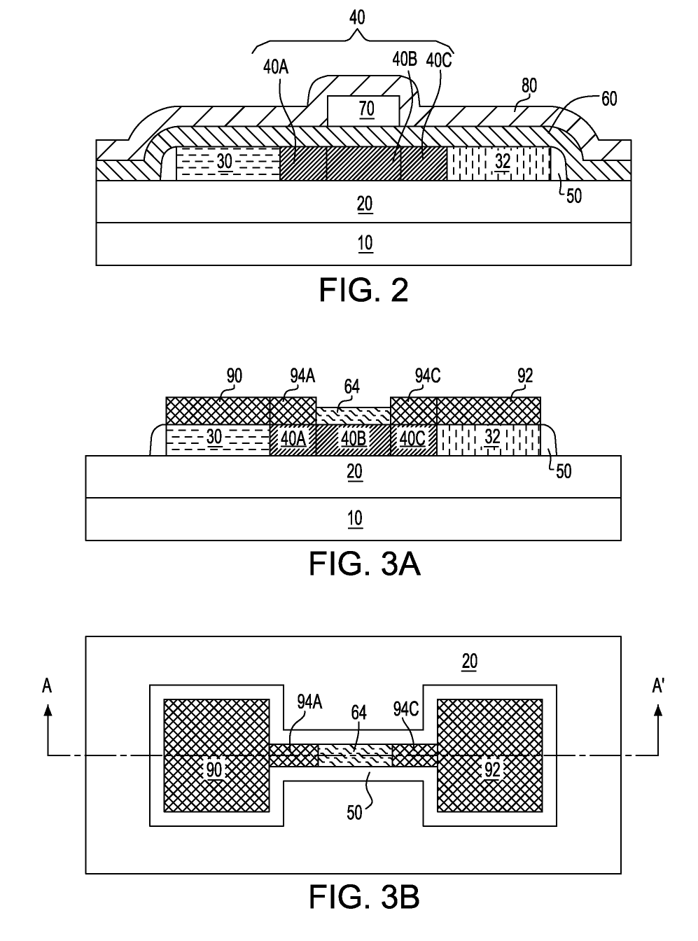

Referring to FIGS. 3A and 3B, the exemplary structure is thereafter annealed at a predetermined elevated temperature at which the first and second metal layers (60, 80) react with the underlying semiconductor material to form various metal semiconductor alloy portions. A fraction of the cathode semiconductor portion 30 reacts with the first and second metal layers (60, 80) to form a cathode metal semiconductor alloy portion 90 having a first thickness and a first composition. A fraction of the anode semiconductor portion 32 reacts with the first and second metal layers (60, 80) to form an anode metal semiconductor alloy portion 92 having the first thickness and the first composition. A fraction of the first semiconductor portion 40A reacts with the first and second metal layers (60, 80) to form a first metal semiconductor alloy portion 94A having the first thickness and the first composition. A fraction of the third semiconductor portion 40C reacts with the first and second metal layers (60, 80) to form a third metal semiconductor alloy portion 94C having the first thickness and the first composition. A fraction of the second semiconductor portion 40B reacts with the first and second metal layers (60, 80) to form a second metal semiconductor alloy portion 94B having a second thickness and a second composition.

Unreacted portions of the second metal layer 80 is thereafter removed by an etch, which may be a wet etch. For example, a wet etch employing aqua regia may be employed. The etch is selective to the various metal semiconductor alloy portions (90, 92, 94A, 94B, 94C).

The second thickness is less than the first thickness. In case the first metal layer 60 and the second metal layer 80 comprise the same material, the first composition and the second composition are the same. In case the first metal layer 60 and the second metal layer 80 comprise different materials, the first composition and the second composition may be different. The metal semiconductor alloys having the first composition are collectively termed first metal semiconductor alloys, while the metal semiconductor alloys having the second composition are collectively termed second metal semiconductor alloys. In case the second metal layer 80 contains an element that the first metal layer 60 does not contain, a full set of metallic components of the first composition may contain at least one additional metallic element than a full set of metallic components of the second composition. For example, the first metal layer 60 may be a Ni layer and the second metal layer 80 may be a Ni—Pt alloy layer, and the full set of metallic components of the first composition consists of Ni and the full set of metallic components of the second composition consists of Ni and Pt, in which case the at least one additional metallic element is Pt.

In case the various semiconductor portions (30, 32, 40A, 40B, 40C) comprises silicon, the first metal semiconductor alloys may comprise a first metal silicide and the second metal semiconductor alloy may comprise a second metal silicide.

The doping of the various semiconductor portions (30, 32, 40A, 40B, 40C) may, or may not, be the same. In one case, all of the various semiconductor portions (30, 32, 40A, 4013, 40C) have the same doping. In another case, the cathode semiconductor portion 30 is doped and the anode semiconductor portion 32 and the first, second, and third semiconductor portions (40A, 40B, 40C) are not doped. In yet another case, the cathode semiconductor portion 30 and the first semiconductor portion 40A are doped and the anode semiconductor portion 32 and the second and third semiconductor portions (4013, 40C) are not doped.

A middle-of-line (MOL) dielectric layer (not shown) is formed on the various metal semiconductor alloy portions (90, 92, 94A, 94B, 94C) and the shallow trench isolation 20. The MOL dielectric layer may comprise a silicon oxide, a silicon nitride, a chemical vapor deposition (CVD) low-k dielectric material, a spin-on low-k dielectric material, or a stack thereof The MOL dielectric layer may contain a mobile ion diffusion barrier layer that prevents diffusion of mobile ions such as sodium and potassium from back-end-of-line (BEOL) dielectric layers. Further, the MOL dielectric layer may contain a stress liner that applies tensile or compressive stress on underlying structures to alter charge carrier mobility. Contacts are formed through the MOL dielectric layer to the cathode metal semiconductor alloy portion 90 and the anode metal semiconductor portion 92.

Since the resistivity of metal semiconductor alloys is about one to two orders of magnitude lower than the resistivity of highly doped semiconductor materials, programming current flows mostly through the various metal semiconductor alloy portions during programming. The abruptly changes in cross-sectional areas at the interface between the first metal semiconductor alloy portion 94A and the second metal semiconductor alloy portion 94B, and at the interface between the second metal semiconductor alloy portion 94B and the third metal semiconductor alloy portion 94C causes the current density to converge or diverge at the two interfaces. Therefore, the divergence of current density achieves high values at the two interfaces, and thus, facilitates electromigration between the two interfaces.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

What is claimed is:

1. An electrical fuse comprising:
a cathode located on a semiconductor substrate and including a cathode semiconductor portion and a cathode metal semiconductor alloy portion, said cathode metal semiconductor alloy portion having a first thickness and vertically abutting said cathode semiconductor portion;
an anode located on said semiconductor substrate and disjoined from said cathode and including an anode semiconductor portion and an anode metal semiconductor alloy portion, said anode metal semiconductor alloy having said first thickness and vertically abutting said anode semiconductor portion; and
a fuselink located on said semiconductor substrate and including:
a first fuselink portion containing a first semiconductor portion and a first metal semiconductor alloy portion, wherein said first metal semiconductor alloy portion has said first thickness and laterally abuts said cathode metal semiconductor alloy portion and vertically abuts said first semiconductor portion;
a second fuselink portion containing a second semiconductor portion and a second metal semiconductor alloy portion, wherein said second metal semiconductor alloy portion has a second thickness and laterally abuts said first metal semiconductor alloy portion and vertically abuts said second semiconductor portion, and said second thickness is less than said first thickness; and
a third fuselink portion containing a third semiconductor portion and a third metal semiconductor alloy portion, wherein said third metal semiconductor alloy portion has said first thickness and laterally abuts second metal semiconductor alloy portion and said anode metal semiconductor alloy portion and vertically abuts said third fuselink semiconductor portion.

2. The electrical fuse of claim 1, wherein said cathode metal semiconductor alloy portion, said first metal semiconductor alloy portion, said third metal semiconductor alloy portion, and said anode metal semiconductor alloy portion have a first composition and said second metal semiconductor alloy portion has a second composition, and wherein said first composition and said second composition are substantially the same.

3. The electrical fuse of claim 1, wherein said cathode metal semiconductor alloy portion, said first metal semiconductor alloy portion, said third metal semiconductor alloy portion, and said anode metal semiconductor alloy portion have a first composition and said second metal semiconductor alloy portion has a second composition, and wherein said first composition and said second composition are different.

4. The electrical fuse of claim 3, wherein said first composition comprises a first metal silicide and said second composition is a second metal silicide.

5. The electrical fuse of claim 3, wherein a full set of metallic components of said first composition contains at least one additional metallic element than a full set of metallic components of said second composition.

6. The electrical fuse of claim 1, further comprising shallow trench isolation located in said semiconductor substrate and abutting said cathode semiconductor portion, said first semiconductor portion, said second semiconductor portion, said third semiconductor portion, and said anode semiconductor portion.

7. The electrical fuse of claim 1, wherein said cathode semiconductor portion, said first semiconductor portion, said second semiconductor portion, said third semiconductor portion, and said anode semiconductor portion have substantially the same height.

8. The electrical fuse of claim 1, wherein said cathode semiconductor portion, said anode semiconductor portion, said first, second, and third semiconductor portion are doped substantially at the same doping concentration and with the same dopant type.

9. A method of manufacturing an electrical fuse comprising:
forming a layer of semiconductor material on a semiconductor substrate;
patterning said layer of said semiconductor material into a cathode semiconductor portion, a fuselink semiconductor portion, and an anode semiconductor portion, wherein said fuselink semiconductor portion laterally abuts said cathode semiconductor portion and said anode semiconductor portion;
forming a first metal layer directly on at least the entirety of a top surface of said fuselink semiconductor portion;
depositing and patterning a dielectric material layer on said first metal layer so that a middle portion of said fuselink semiconductor portion is covered by said dielectric material layer, while two end portions of said fuselink semiconductor portion are not covered by said dielectric material layer;
forming a second metal layer directly on said first metal layer and said dielectric material layer; and
forming a first metal semiconductor alloy having a first thickness at least on said two end portions of said fuselink semiconductor portion, while forming a second metal semiconductor alloy having a second thickness on said middle portion of said fuselink semiconductor portion, wherein said second thickness is less than said first thickness.

10. The method of claim 9, wherein said first metal layer and said second metal layer have substantially the same composition.

11. The method of claim 9, wherein said first metal layer and said second metal layer have different compositions.

12. The method of claim 11, wherein said first metal semiconductor alloy comprises a first metal silicide and said second metal semiconductor alloy comprises a second metal silicide.
